(19) United States
(12) Patent Application Publication
(10) Pub. No.: US 2017/0277484 A1
(43) Pub. Date: Sep. 28, 2017

(54) PRINTER, AND CONTROL METHOD OF A PRINTER

(71) Applicant: SEIKO EPSON CORPORATION, Tokyo (JP)

(72) Inventor: Akimasa TAKAGI, Nagano-Ken (JP)

(73) Assignee: SEIKO EPSON CORPORATION, Tokyo (JP)

(21) Appl. No.: 15/467,678

(22) Filed: Mar. 23, 2017

(30) Foreign Application Priority Data
Mar. 28, 2016 (JP) 2016-064270
Mar. 28, 2016 (JP) 2016-064271

(51) Int. Cl. G06F 3/12; G06K 15/02; B41J 29/38

(52) U.S. Cl. CPC G06F 3/1231; B41J 29/38; G06F 3/121; G06F 3/1204; G06F 3/1225; G06F 3/1287; G06K 15/022

(57) ABSTRACT

A printer enables determining the replacement status of a printer, thereby enabling forecasting problems specific to a printer location (such as a checkout lane) and problems specific to a business, and enabling easily devising a solution to the problems. A printer 40 disposed to a printer location has an interface 48 to which memory 34 associated with the printer location (lane n) is removably connected; and a printer replacement information writer that writes printer replacement information through the interface 48 to the memory 34 at a specific time.

### BACKGROUND

1. Technical Field

The present invention relates to a printer and a control method of a printer, and relates more particularly to a printer capable of determining the replacement status of the printer (such as the replacement frequency of each printer, and the replacement frequency of all printers in a business), and to a printer control method.

2. Related Art

Printers (network printers) that communicate with a host computer using a network address such as an IP address are known from the literature.

When one printer of this type (referred to below as the original printer) is replaced with another printer (referred to below as the replacement printer) (such as when a malfunctioning printer is replaced with a separate, normally operating printer), printer information, such as the IP address of the original printer, must be transferred to the replacement printer.

However, because some degree of technical knowledge or a dedicated computer is required to set the printer information (configuration) in the replacement printer, it is difficult for a non-technical user (such as a store employee) to quickly and accurately set the printer information in the replacement printer when the printer is used in a supermarket in which a POS system is deployed, for example.

To solve this problem when replacing a printer, JP-A-2011-164872 proposes reading printer information from a USB memory stick or other external memory device and setting the printer information read from the external memory device in the replacement printer.

However, while the method of JP-A-2011-164872 enables relatively easily setting the printer information in the replacement printer, it is not able to determine the replacement status of the printers (for example, how frequently the printer used at a specific location is replaced or how frequently printers throughout the business (store) are replaced). As a result, it is not possible to forecast problems specific to where a particular printer is installed (such as a particular checkout lane in a store), or problems specific to the business (store), and devising an appropriate solution is therefore difficult.

### SUMMARY

The invention is directed to the foregoing problem, and an objective of the invention is to provide a printer and a print control method that enable determining the replacement status of a printer (such as the replacement frequency of individual printers, and the replacement frequency of all printers in a business), and as a result enable forecasting problems specific to a particular printer location (such as a particular checkout lane in a store), and problems specific to a business (store), and thereby enable easily devising an appropriate solution.

To achieve the foregoing objective, one aspect of the invention is a printer disposed to a printer location, and including: an interface to which memory associated with the printer location is removably connected; and a printer replacement information writer configured to write printer replacement information through the interface to the memory at a specific time.

A printer according to this aspect of the invention enables determining the replacement status of a printer (such as the replacement frequency of a particular printer, and the replacement frequency of all printers in a business), and as a result enables forecasting the presence of problems specific to a particular printer location (such as a particular checkout lane in a store), and problems specific to the business (store), and thereby enables easily devising an appropriate solution.

This is possible because the printer replacement information can be written by the printer replacement information writer to memory at a specific time through the interface, and because the replacement status of the printer can be known by displaying on a display or by printing out the printer replacement information that was written to memory.

In another aspect of the invention, the printer replacement information preferably includes at least one of an identifier, IP address, lane ID, printer replacement history, and printer replacement count.

This aspect of the invention enables the printer replacement information writer to write at least one of an identifier, IP address, lane ID, printer replacement history, and printer replacement count to memory as the printer replacement information.

In another aspect of the invention, the identifier is preferably the serial number of the printer, or the MAC address of the printer.

This aspect of the invention enables the printer replacement information writer to write the serial number of the printer, or the MAC address of the printer to memory as the printer identifier.

Further preferably in another aspect of the invention, the printer determines if the identifier of the printer matches the printer identifier stored in the memory, and determines the printer was replaced if the identifiers do not match.

This aspect of the invention enables the printer to determine if the identifier of the printer matches the printer identifier stored in the memory, and determine the printer was replaced if the identifiers do not match.

Another aspect of the invention is a control method of a printer that is disposed to a printer location and has an interface to which memory associated with the printer location is removably connected, the control method including: a printer replacement information writing step of writing printer replacement information through the interface to the memory at a specific time.

A control method of a printer according to this aspect of the invention enables determining the replacement status of a printer (such as the replacement frequency of a particular printer, and the replacement frequency of all printers in a business), and as a result enables forecasting problems specific to a particular printer location (such as a particular checkout lane in a store), and problems specific to the business (store), and thereby enables easily devising an appropriate solution.

This is possible because the printer replacement information can be written by the printer replacement information writing step to memory at a specific time through the interface, and because the replacement status of the printer can be known by displaying on a display or by printing out the printer replacement information that was written to memory.

Another aspect of the invention is a printer disposed to a printer location, and including: an interface to which memory associated with the printer location is removably connected; a printer replacement information writer configured to write printer replacement information through the interface to the memory; and a communicator configured to communicate with a host computer, and send the printer replacement information stored in the memory to the host computer at a specific time.

A printer according to this aspect of the invention enables knowing if a printer was replaced (the replacement status of a printer) in real time (or substantially real time).

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 illustrates the configuration of a POS system 10 in which the printer and the printer control method of the invention are used.

FIG. 2 is an oblique view of one example of a memory module 30.

FIG. 3 is an oblique view of one example of a memory module 30.

FIG. 4 is a block diagram illustrating an exemplary hardware configuration of the memory module 30.

FIG. 5 is a block diagram illustrating an exemplary hardware configuration of the memory module 30.

FIG. 6 illustrates storage areas in the nonvolatile memory 34.

FIG. 7 is a block diagram showing an example of the functional configuration of a printer 40.

FIG. 8 is a flow chart describing an example of the operation (printer control method) of the printer 40.

FIG. 9 is a flow chart of an example of the operation of the replacement printer 40 when the IP address stored in the ROM 42c of the replacement printer 40 is changed to a different IP address based on, for example, an operation of the host computer 20 (or an operation of the replacement printer 40).

FIG. 10 is a flow chart of the process of reporting the printer replacement information (printer replacement history and printer replacement count) written to nonvolatile memory 34 to the host computer 20.

### DESCRIPTION OF EMBODIMENTS

Preferred embodiments of the present invention are described below with reference to the accompanying figures. Note that corresponding elements in the figures are identified by the same reference numerals, and redundant description thereof is omitted or abbreviated below.

A printer according to the invention is described first below.

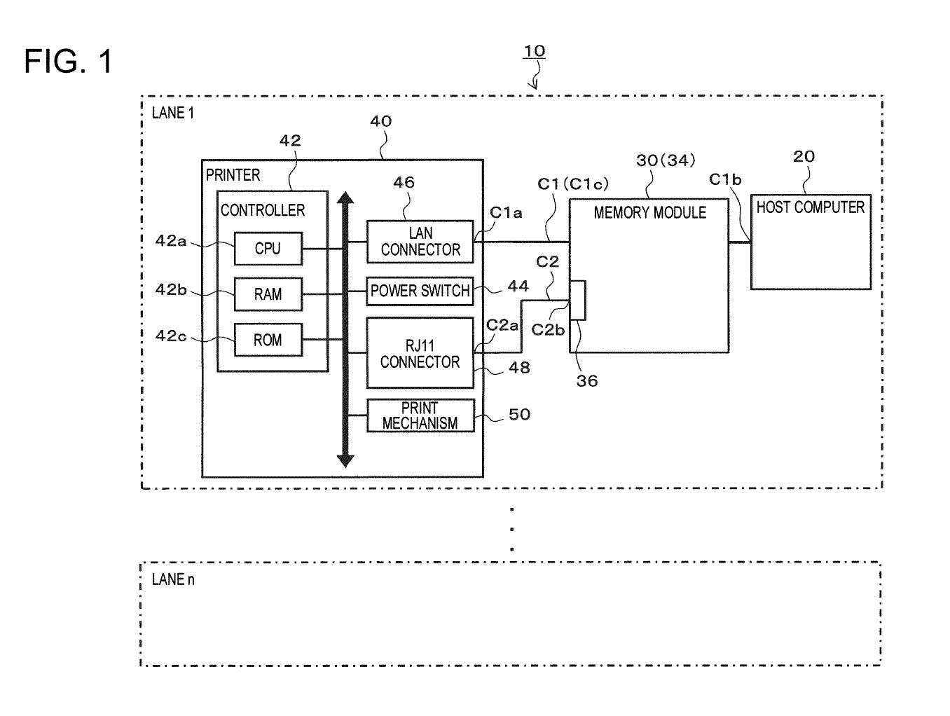

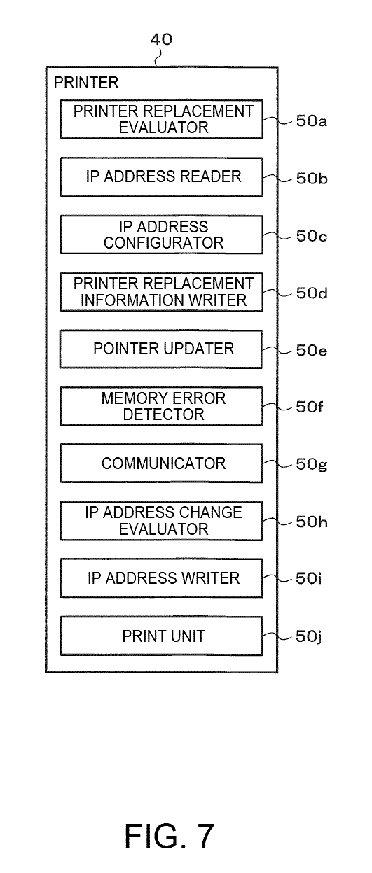

FIG. 1 illustrates the configuration of a POS system 10 in which a printer and printer control method according to the invention are deployed. FIG. 7 is a block diagram illustrating the functional configuration of the printer 40.

As shown in FIG. 1 and FIG. 7, a printer 40 according to this embodiment is a printer installed at a specific printer location (such as a checkout lane), and has an RJ11 connector 48 (interface) to which nonvolatile memory 34 (memory) related to the printer location is removably connected; and a printer replacement information writer 50d that at a specific time writes printer replacement information through the RJ11 connector 48 to the nonvolatile memory 34.

A printer 40 according to this embodiment therefore enables determining the replacement status of individual printers (such as the replacement frequency of individual printers, and the replacement frequency of all printers in a business), and as a result enables forecasting the occurrence of problems specific to a particular printer location (such as a particular checkout lane in a store), and problems specific to the business (store), and thereby enables easily devising an appropriate solution.

This is possible because the printer replacement information can be written by the printer replacement information writer 50d to memory at a specific time through the RJ11 connector 48, and because the replacement status of the printer can be known by displaying on a display or by printing out the printer replacement information that was written to memory.

A POS system 10 in which a printer and printer control method according to the invention are deployed is described below with reference to the accompanying figures.

As shown in FIG. 1, the POS system 10 includes a host computer 20, memory module 30, printer 40, LAN cable C1, and modular cable C2. A host computer 20, memory module 30, printer 40, LAN cable C1, and modular cable C2 are disposed to each checkout lane (lane 1 to lane n) in a supermarket or other retail store.

The configuration of the host computer 20 is described first.

While not shown in the figures, the hardware configuration of the host computer 20 includes a CPU and RAM, ROM, a hard disk drive, and interfaces connected to the CPU through respective buses.

The printer 40 is connected to the host computer 20 through an interface (not shown in the figure). Also connected to the host computer 20 through appropriate interfaces are (not shown) a barcode reader for reading barcodes, a keyboard for inputting information including the payment amount received from the customer, and a display for displaying product name and price information, for example.

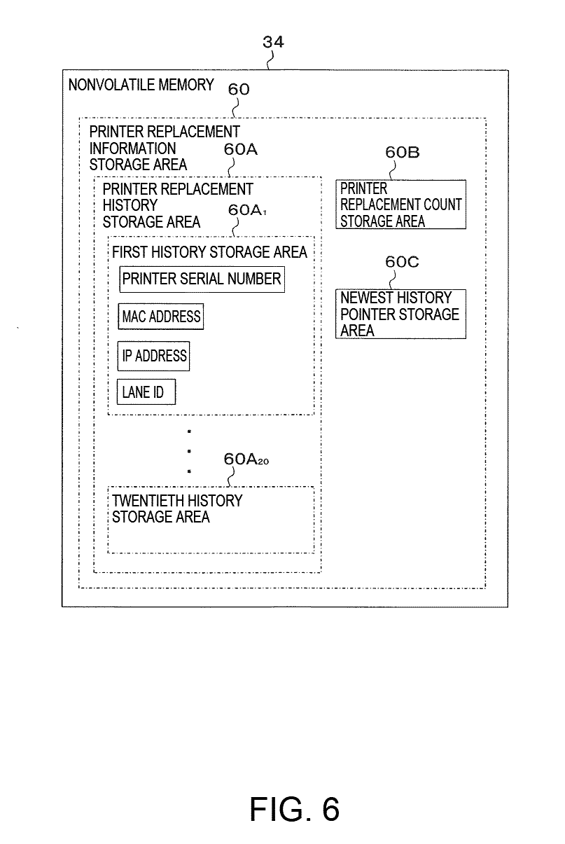

The functional configuration of the host computer 20 includes functions for executing a transaction process based on input from the barcode reader and keyboard; generating print data; communicating with the printer 40 through the LAN cable C1 (typically an Ethernet (R) cable); sending print data and commands (such as a get memory module status command, a get printer replacement count command, and a get printer replacement history command) through the LAN cable C1 to the printer 40; setting the IP address in the ROM 42c of the printer 40; and changing the IP address stored in the ROM 42c of the printer 40. Note that FIG. 6 shows an example in which the cash drawer 60 is connected to the RJ11 connector 48 instead of the nonvolatile memory (memory module 30) in FIG. 1.

These functions are embodied mainly by the host computer 20 (CPU) running specific programs read from ROM or hard disk drive to RAM (more specifically, the operating system, POS application, printer driver (including a status API), and a utility for setting or changing the IP address). While not shown in the figures, the host computer 20 is connected to the store network through an interface.

The memory module 30 is described next.

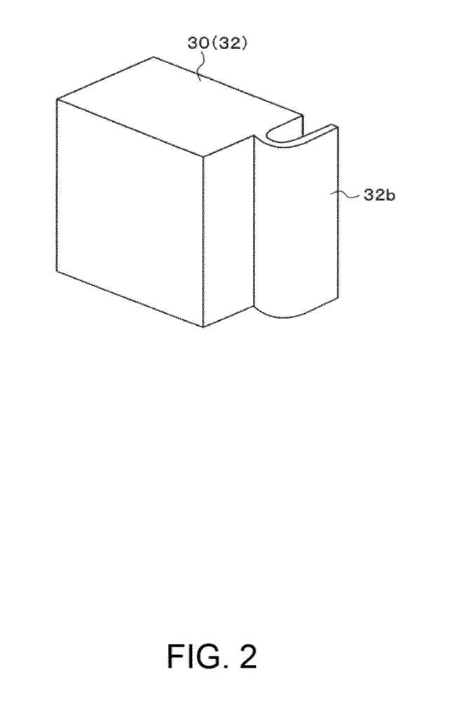

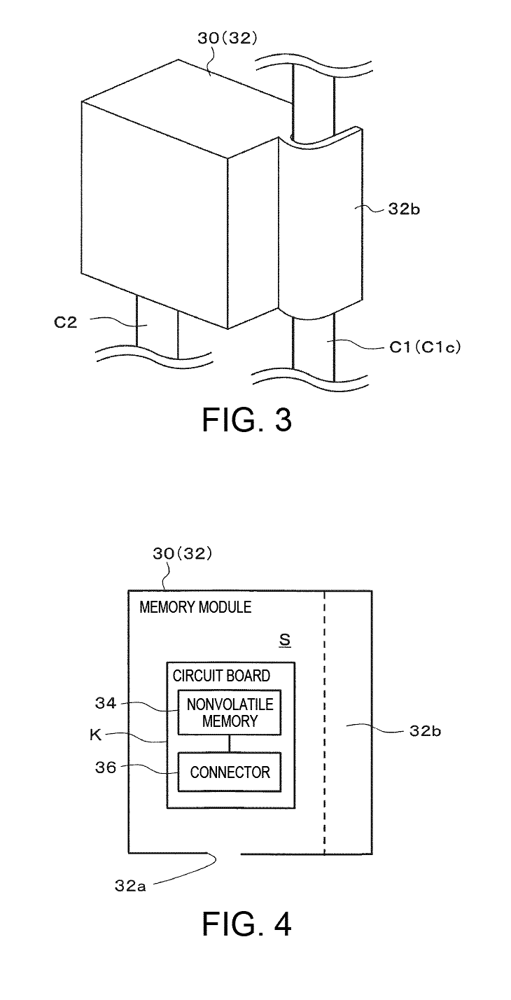

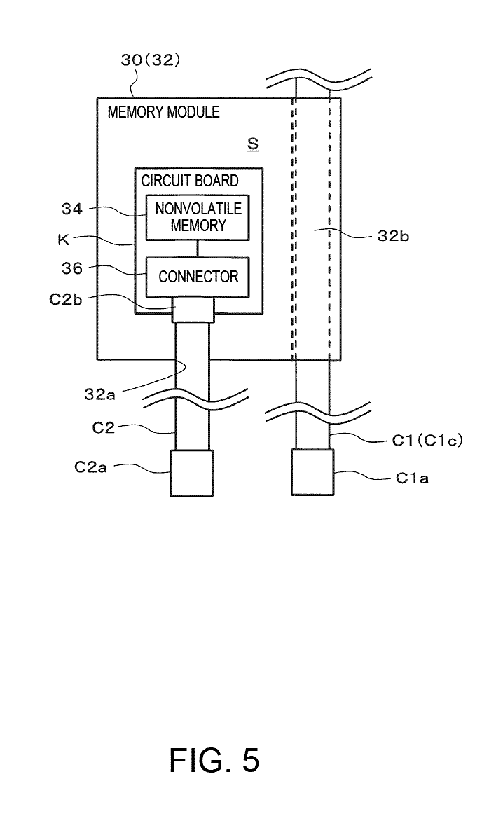

FIG. 2 and FIG. 3 are oblique views of the memory module 30, and FIG. 4 and FIG. 5 are block diagrams illustrating the hardware configuration of the memory module 30.

As shown in FIG. 2 and FIG. 4, the memory module 30 includes a case 32 that connects to the LAN cable C1, and nonvolatile memory 34 inside the case 32. The nonvolatile memory 34 is attached to the LAN cable C1 by affixing the memory module 30 to the LAN cable C1 as described below.

The case 32 is a rectangular plastic housing, and has an internal space S where the nonvolatile memory 34 is housed as shown in FIG. 4. The case 32 has a through-hole 32a connecting the internal space S to the outside. As shown in FIG. 5, the modular cable C2 passes through this through-hole 32a.

The nonvolatile memory 34 is an EEPROM device, for example, and is mounted on a circuit board K with a connector 36 electrically connected to the EEPROM device. The circuit board K (nonvolatile memory 34 and connector 36) is installed in the internal space S of the case 32.

The memory module 30 (nonvolatile memory 34) is provided (such as sold) with the printer 40 as a printer set. The memory module 30 (nonvolatile memory 34) is attached to the LAN cable C1 as shown in FIG. 3 and FIG. 5 by the buyer.

The means of attaching (connecting) the memory module 30 (nonvolatile memory 34) to the LAN cable C1 is, for example, U-shaped a clip 32b that is disposed to the case 32. As shown in FIG. 3, the memory module 30 (nonvolatile memory 34) is attached to the LAN cable C1 by fitting the LAN cable C1 (cable C1c) into the clip 32b. As a result, the nonvolatile memory 34 is associated with the printer location (checkout lane).

The means of attaching the nonvolatile memory 34 to the LAN cable C1 is obviously not so limited, and may be a clip (not shown in the figure) that pinches the LAN cable C1, an adhesive or screw disposed to the case 32 to hold the LAN cable C1, or other type of fastener or connector.

FIG. 6 illustrates storage areas in the nonvolatile memory 34.

As shown in FIG. 6, the nonvolatile memory 34 has a printer replacement information storage area 60. The printer replacement information storage area 60 includes a printer replacement history storage area 60A, printer replacement count storage area 60B, and newest history pointer storage area 60C.

The printer replacement history storage area 60A includes first history storage area 60A₁ to twentieth history storage area 60A₂₀. First history storage area 60A₁ to twentieth history storage area 60A₂₀ each store printer replacement information including, in this example, the printer serial number, MAC address, IP address, and lane ID. The printer replacement count storage area 60B stores a printer replacement count as the printer replacement information. The newest history pointer storage area 60C stores a pointer (address) identifying the most recent history storage area in the nonvolatile memory 34 (that is, first to twentieth history storage area 60A₁ to 60A₂₀) to which printer replacement information was written.

The connector 36 is a connector provided for connecting the nonvolatile memory 34 to the printer 40.

As shown in FIG. 1, the nonvolatile memory 34 is connected to the printer 40 (RJ11 connector 48) by a modular cable C2. More specifically, one plug C2a of the modular cable C2 is connected to the printer 40 (RJ11 connector 48), and the other plug C2b is connected to the nonvolatile memory 34 (connector 36).

The printer 40 is described next.

The printer 40 in this example is typically a receipt printer (such as a dot impact, thermal, or inkjet printer), and as shown in FIG. 1 the hardware configuration of the printer 40 includes a controller 42 and a power switch 44, LAN connector 46, RJ11 connector 48, and print mechanism 50 connected through a bus to the controller 42. The printer 40 is installed at the printer location (checkout lane).

The controller 42 includes a CPU 42a, RAM 42b, and ROM 42c. The ROM 42c is flash ROM or other type of nonvolatile memory device, and includes storage areas for storing the printer serial number, MAC address, IP address, and lane ID. The printer serial number is a unique identifier (such as the manufacturer serial number) assigned to the printer 40. The MAC address is the MAC address unique to the printer 40. The printer serial number and MAC address are previously stored in ROM 42c (or other ROM device).

The IP address is a unique IP address assigned to the printer 40 (or the checkout lane). The IP address is, for example, set in ROM 42c by an operation of the host computer 20. The IP address stored to ROM 42c may also be changed by an operation of the host computer 20 to a different IP address. The least significant byte of the IP address is the lane ID. For example, if the IP address is 123.45.67.n (where n=1), n denotes the lane ID (the lane ID of lane 1 in this example). The lane ID is a unique identifier assigned to a specific lane. Programs, such as firmware (control programs) are also stored to ROM 42c.

The power switch 44 is a power supply switch for turning the power supply to the printer 40 on and off.

The LAN connector 46 is a connector for connecting the printer 40 to the host computer 20. The printer 40 (LAN connector 46) and host computer 20 can be connected by a LAN cable C1 as shown in FIG. 1. More specifically, one plug C1a of the LAN cable C1 is connected to the printer 40 (LAN connector 46), and the other plug C1b is connected to the host computer 20.

The RJ11 connector 48 is a connector (interface) to which the memory module 30 (nonvolatile memory 34) is removably connected. As shown in FIG. 1, the RJ11 connector 48 and memory module 30 can connect through the modular cable C2. More specifically, one plug of the modular cable C2 is connected to the RJ11 connector 48, and the other plug C2b is connected to the memory module 30 (connector 36).

The print mechanism 50 comprises a printhead, paper feed mechanism, and paper cutting mechanism (all not shown in the figures).

FIG. 17 is a block diagram illustrating an example of the functional configuration of the printer 40.

As shown in FIG. 7, the functional configuration of the printer 40 includes a printer replacement evaluator 50a, IP address reader 50b, IP address configurator 50c, printer replacement information writer 50d, pointer updater 50e, memory error detector 50f, communicator 50g, IP address change evaluator 50h, IP address writer 50i, and print unit 50j.

The above functions are embodied by the printer 40 (CPU 42a) running firmware or other specific programs read from ROM 42c to RAM 42b.

The printer replacement evaluator 50a determines, at a specific time, if the printer 40 to which it belongs was replaced. This specific time is, for example, when the power switch 44 of the printer 40 is turned on. More specifically, the printer replacement evaluator 50a determines if the printer serial number stored in the replacement history storage area (that is, first history storage area 60A₁ to twentieth history storage area 60A₂₀) of the nonvolatile memory 34 specified by the pointer stored in the newest history pointer storage area 60C, and the printer serial number stored in the ROM 42c of the printer 40, match, and determines the printer 40 was replaced if the serial numbers are not the same. If the printer serial numbers are the same, the printer replacement evaluator 50a determines the printer 40 was not replaced.

The IP address reader 50b reads the IP address from the memory module 30 (nonvolatile memory 34) through the modular cable C2 and the RJ11 connector 48. More specifically, the IP address reader 50b reads the IP address stored in the history storage area (that is, first history storage area 60A₁ to twentieth history storage area 60A₂₀) of the nonvolatile memory 34 specified by the pointer stored in the newest history pointer storage area 60C.

The IP address configurator 50c sets the IP address read by the IP address reader 50b in the printer 40. More specifically, the IP address configurator 50c stores the IP address read by the IP address reader 50b in the ROM 42c of the same printer 40 as the IP address configurator 50c.

The printer replacement information writer 50d writes the printer replacement information (at least one of the printer serial number, MAC address, IP address, lane ID, and printer replacement count) through the RJ11 connector 48 and modular cable C2 to the memory module 30 (nonvolatile memory 34) at a specific time. The printer serial number, MAC address, IP address, and lane ID are equivalent to the printer replacement history. The printer serial number and MAC address are examples of printer identifiers. The specific time is, for example, when the printer 40 is replaced, and when the printer 40 power is turned on.

More specifically, the printer replacement information writer 50d writes the printer replacement history to the history storage area (that is, first history storage area 60A₁ to twentieth history storage area 60A₂₃) of the nonvolatile memory 34 specified by the pointer stored in the newest history pointer storage area 60C (the pointer updated by the pointer updater 50e as described below). The printer replacement information writer 50d also updates the printer replacement count (increments the printer replacement count by one), and writes the updated printer replacement count in the printer replacement count storage area 60B of the nonvolatile memory 34.

The pointer updater 50e updates the pointer stored in the newest history pointer storage area 60C of the nonvolatile memory 34 to point to the next history storage area. For example, the pointer updater 50e sequentially updates the pointer stored in the newest history pointer storage area 60C of the nonvolatile memory 34 from first history storage area 60A₁ to second history storage area 60A₂, third history storage area 60A₃, and so forth to twentieth history storage area 60A₂₀ so that the pointer points to the first history storage area 60A₁, second history storage area 60A₂, third history storage area 60A₃, and so forth.

The memory error detector 50f detects information related to nonvolatile memory 34 errors. Information related to nonvolatile memory 34 errors is information about the status of the nonvolatile memory 34, such as normal operation, connection errors, read verify errors, write verify errors, and timeout errors.

The communicator 50g communicates with the host computer 20, and is embodied by, for example, a LAN controller (not shown in the figures). The communicator 50g sends (reports) the printer replacement history stored in the nonvolatile memory 34 (printer replacement information storage area 60) to the host computer 20 at a specific time. This specific time is when a specific first command is received from the host computer 20 (referred to below as a get printer replacement count command or get printer replacement history command).

When a specific second command (referred to below as a get memory module status command) is received from the host computer 20, the communicator 50g sends (reports) information related to nonvolatile memory 34 errors detected by the memory error detector 50f to the host computer 20.

The IP address change evaluator 50h determines if the IP address stored in the ROM 42c of the printer 40 was changed to a different IP address.

If the IP address change evaluator 50h determines the IP address stored in the ROM 42c of the printer 40 was changed to a different IP address, the IP address writer 50i writes the new IP address to the history storage area (that is, first history storage area 60A₁ to twentieth history storage area 60A₂₀) of the nonvolatile memory 34 specified by the pointer stored in the newest history pointer storage area 60C through the RJ11 connector 48 and modular cable C2.

The print unit 50j controls the print mechanism 50 to print a receipt based on the print data received from the host computer 20.

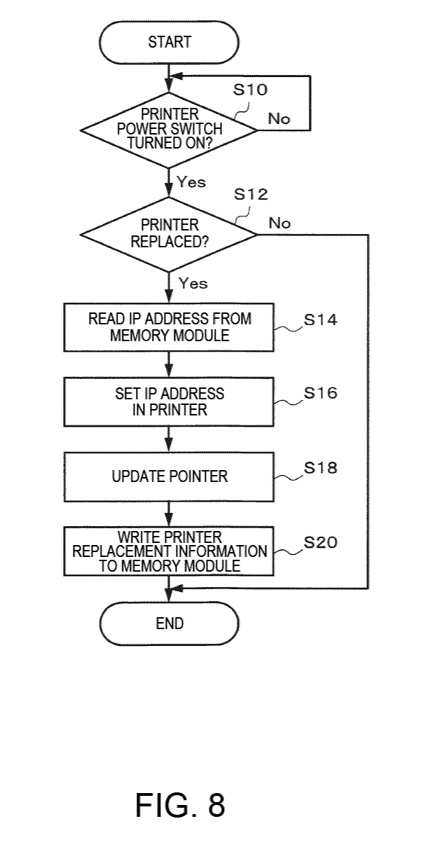

An example of the operation (print control method) of the printer 40 according to this embodiment is described next with reference to FIG. 8.

FIG. 8 is a flow chart for describing the operation (printer control method) of the printer 40 according to this embodiment.

The printer control method according to this embodiment is described below as an example the operation when the printer 40 installed on a particular checkout lane (lane 1 in this example) in the POS system 10 shown in FIG. 1 fails, and the failed printer 40 (referred to herein as the original printer 40) is replaced with another printer 40 (referred to herein as the replacement printer 40) that operates normally.

The process shown in FIG. 8 is a process executed by the replacement printer 40, for example, particularly by the (CPU 42a) of the replacement printer 40 executing a specific program, such as firmware, copied from ROM 42c to RAM 42b.

Note that the operation described below assumes that the following content is previously stored in the nonvolatile memory 34 associated with the specific printer location (lane 1 in this example). More specifically, the printer replacement information stored in the first history storage area 60A₁ of the nonvolatile memory 34 includes the printer serial number of the original printer 40, the MAC address of the original printer 40, the IP address (such as 123.45.67.1) assigned to the original printer 40 (lane 1), and the lane ID (1 in this example). Also in this example, printer replacement information is not stored in the second to twentieth history storage areas 60A₂ to 60A₂₀. A printer replacement count of 0 is also stored as printer replacement information in the printer replacement count storage area 60B of the nonvolatile memory 34. A pointer pointing to the first history storage area 60A₁, which is the most recent history storage area, is also stored in the newest history pointer storage area 60C of the nonvolatile memory 34.

When the printer 40 installed at lane 1 fails, the original printer 40 is replaced with the replacement printer 40 by the process described below before the process shown in FIG. 8 executes.

First, the replacement printer 40 (LAN connector 46) and host computer 20 are connected. More specifically, the LAN cable C1 is disconnected from the original printer 40 (LAN connector 46), and the disconnected LAN cable C1 is then connected to the replacement printer 40 (LAN connector 46). The replacement printer 40 (RJ11 connector 48) and nonvolatile memory 34 are also connected. More specifically, the modular cable C2 is disconnected from the original printer 40 (RJ11 connector 48), and the disconnected modular cable C2 is connected to the replacement printer 40 (RJ11 connector 48). Because the nonvolatile memory 34 storing the IP address (such as 123.45.67.1) assigned to the original printer 40 (lane 1) is attached to the LAN cable C1 (see FIG. 3, FIG. 5), or more specifically because the nonvolatile memory 34 is related to the printer location (lane 1) (is physically tied to the LAN cable C1), the effect of this operation is described below.

First, there is no need to prepare a separate external memory device each time a printer 40 is replaced. Second, managing the nonvolatile memory 34 is easier than in the related art, and a suitable nonvolatile memory 34 (memory module 30) device storing the IP address to be set in the replacement printer 40 can be prepared more quickly than in the related art. Third, there is no possibility of creating a nonvolatile memory 34 (memory module 30) device storing an IP address different from the IP address that is stored in the nonvolatile memory 34 (memory module 30) storing the correct IP address and should be set in the replacement printer 40. As a result, the correct IP address can be set in the replacement printer 40. Fourth, there is no chance of losing the nonvolatile memory 34 (memory module 30).

As described above, because the nonvolatile memory 34 is connected to the LAN cable C1, that is, because the nonvolatile memory 34 is associated with the printer location (lane 1) (because it is physically attached to the LAN cable C1), when the printer 40 is replaced, even non-technical users can quickly and correctly set the IP address (such as 123.45.67.1) assigned to the original printer 40 (lane 1) in the replacement printer 40.

Note that the replacement printer 40 (LAN connector 46) and host computer 20 are connected, and the replacement printer 40 (RJ11 connector 48) and nonvolatile memory 34 are connected, while the power switch 44 of the replacement printer 40 is off.

The power switch 44 of the replacement printer 40 is then turned on.

When the power switch 44 of the replacement printer 40 turns on (step S10: Yes), the replacement printer 40 (printer replacement evaluator 50a) determines whether or not its printer 40 was replaced (step S12). More specifically, the printer replacement evaluator 50a determines if the printer serial number stored in the history storage area specified by the pointer stored in the newest history pointer storage area 60C matches the printer serial number stored in the ROM 42c of its printer 40, and if the serial numbers do not match, determines that the printer 40 was replaced (step S12: Yes).

Because the printer serial number (the printer serial number of the original printer 40 in this example) stored in the history storage area (first history storage area 60A₁ in this example) specified by the pointer stored in the newest history pointer storage area 60C, and the printer serial number stored in the ROM 42c of the same printer 40 as the printer replacement evaluator 50a (that is, the serial number of the replacement printer 40), do not match, the printer replacement evaluator 50a determines that its printer 40 is a replacement printer 40 (that is, the printer 40 was replaced) (step S12: Yes). However, if the serial numbers do not match, the printer replacement evaluator 50a determines that the printer 40 was not replaced (step S12:No), and the process ends.

Next, if the replacement printer 40 (IP address reader 50b) determines that the printer 40 was replaced (step S12: Yes), it reads the IP address from the memory module 30 (nonvolatile memory 34) through the modular cable C2 and RJ11 connector 48 (step S14). More specifically, the IP address reader 50b reads the IP address stored in the history storage area (first history storage area 60A₁ in this example) specified by the pointer stored in the newest history pointer storage area 60C.

Next, the replacement printer 40 (IP address configurator 50c) sets the IP address read by the IP address reader 50b as the address of the printer 40 (step S16). More specifically, the IP address configurator 50c stores the IP address read by the IP address reader 50b in the ROM 42c of its printer 40.

A communication path (such as a TCP connection) is established between the host computer 20 and replacement printer 40 by executing a known process based on the IP address that is set. Thereafter, the replacement printer 40 (communicator 50g) communicates with the host computer 20 through the LAN cable C1 based on the set IP address. For example, when print data is received from the host computer 20 through the LAN cable C1 (and LAN connector 46), the replacement printer 40 (print unit 50j) controls the print mechanism 50 to print a receipt based on the received print data.

Next, the printer 40 (pointer updater 50e) updates the pointer stored in the newest history pointer storage area 60C of the nonvolatile memory 34 to point to the next history storage area (in this example, second history storage area 60A₂) (step S18).

Next, the printer 40 (printer replacement information writer 50d) writes printer replacement information (the printer replacement history and printer replacement count) through the RJ11 connector 48 and modular cable C2 to the memory module 30 (nonvolatile memory 34) (step S20). This is equivalent to the printer replacement information writing step of the invention. More specifically, the printer replacement information writer 50d writes the printer replacement history to the history storage area (second history storage area 60A₂ in this example) pointed to by the pointer stored in the newest history pointer storage area 60C (the pointer that was updated by the pointer updater 50e in step S18). The printer replacement information writer 50d also updates the printer replacement count (0 at this time) by adding one to the count, and writes the new printer replacement count (1) to the printer replacement count storage area 60B of the nonvolatile memory 34.

Next, if the IP address stored in the ROM 42c of the printer 40 was changed to a different IP address by an operation of the host computer 20 (or an operation of the printer 40), the replacement printer 40 executes the following operation.

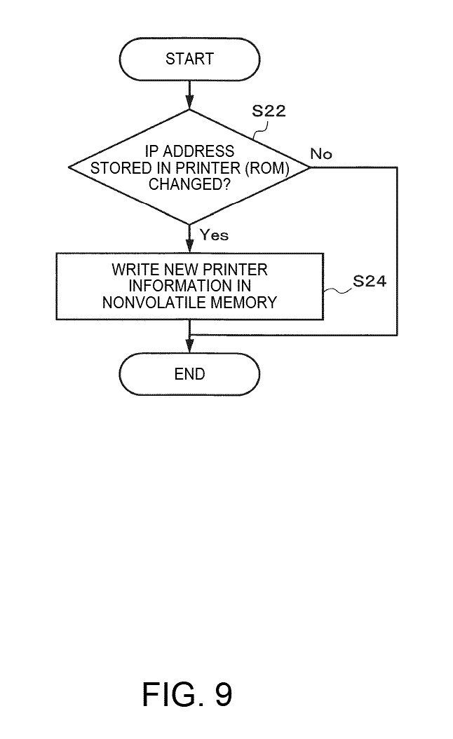

FIG. 9 is a flow chart describing an example of the operation of the printer 40 when the IP address stored in the ROM 42c of the printer 40 was changed to a different IP address by an operation of the host computer 20 (or an operation of the printer 40).

First, the replacement printer 40 (IP address change evaluator 50h) determines if the IP address stored in the ROM 42c of the same printer 40 was changed to a different IP address (step S22). If the replacement printer 40 (IP address change evaluator 50h) determines the IP address stored in the ROM 42c of the same printer 40 was changed to a different IP address (step S22: Yes), the replacement printer 40 (IP address writer 50i) writes the new IP address through the RJ11 connector 48 and modular cable C2 to the history storage area (second history storage area 60A₂ in this example) indicated by the pointer stored in the newest history pointer storage area 60C (step S24).

In this way, printer replacement information (printer replacement history and printer replacement count) is written to the nonvolatile memory 34 linked to a specific printer location (lane 1 in this example) whenever the printer 40 associated with that nonvolatile memory 34 changes.

The printer replacement information (printer replacement history and printer replacement count) that was written to the nonvolatile memory 34 is then reported to the host computer 20 as described below.

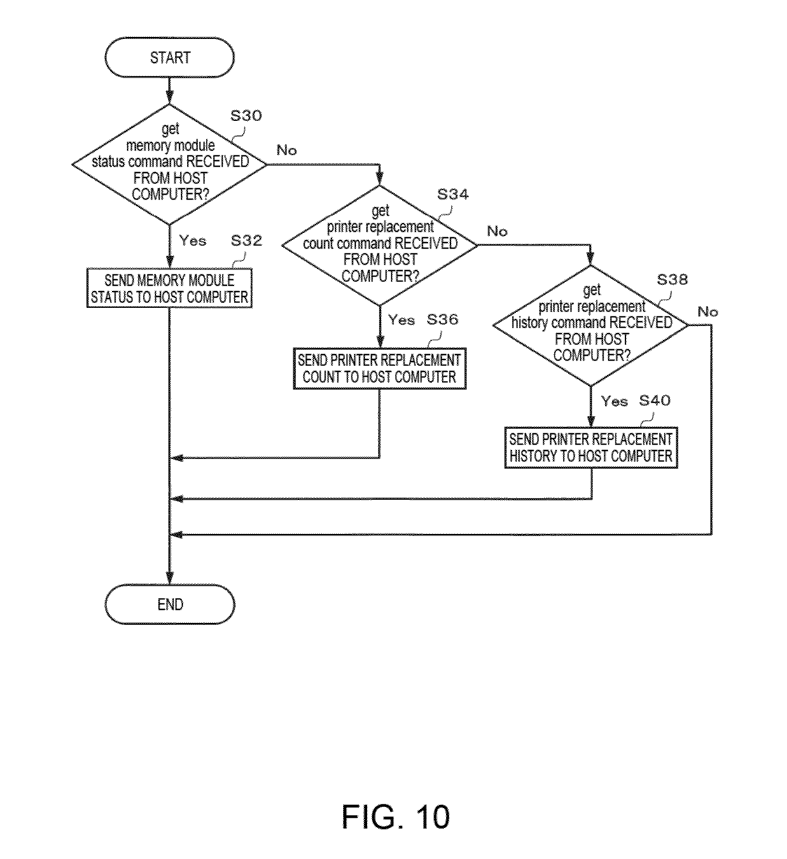

FIG. 10 is a flow chart describing the process of reporting the printer replacement information (printer replacement history and printer replacement count) that was written to the nonvolatile memory 34 to the host computer 20.

The printer 40 (the communicator 50g of the replacement printer 40 in this example) first determines if a get memory module status command (a specific second command) sent from the host computer 20 was received (step S30). If the command was received (step S30: Yes), the printer 40 sends (reports) the information related to nonvolatile memory 34 errors detected by the memory error detector 50f to the host computer 20 (step S32). The host computer 20 receives and stores the information related to nonvolatile memory 34 errors sent from the printer 40 to RAM or other storage device of the host computer 20. Note that the host computer 20 sends the get memory module status command (specific second command) to the printer 40 (the replacement printer 40, for example) at a regular or irregular interval (such as an interval of several minutes).

The printer 40 (the communicator 50g of the replacement printer 40 in this example) also determines if a get printer replacement count command (a specific first command) sent from the host computer 20 was received (step S34). If the command was received (step S34: Yes), the printer 40 sends (reports) the printer replacement count stored in the printer replacement count storage area 60B of the nonvolatile memory 34 to the host computer 20 (step S36). The host computer 20 receives and stores the printer replacement count sent from the printer 40 to RAM or other storage device of the host computer 20.

When the printer replacement count sent from the printer 40 is received, the host computer 20 also determines if the printer replacement count changed. If the printer replacement count is detected to have changed (if the printer replacement count is detected to have changed from 0 to 1 in this example), the host computer 20 executes a process such as sending the get printer replacement history command (specific first command) to the printer 40. Note that the host computer 20 sends the get printer replacement count command (specific first command) to the printer 40 (the replacement printer 40, for example) at a regular or irregular interval (such as an interval of several minutes).

The printer 40 (the communicator 50g of the replacement printer 40 in this example) also determines if a get printer replacement history command (a specific first command) sent from the host computer 20 was received (step S38). If the command was received (step S38: Yes), the printer 40 sends (reports) the printer replacement history stored in the printer replacement history storage area 60A (first history storage area 60A₁ to twentieth history storage area 60A₂₀) of the nonvolatile memory 34 to the host computer 20 (step S40). The host computer 20 receives and stores the printer replacement history sent from the printer 40 to RAM or other storage device of the host computer 20. Note that the host computer 20 sends the get printer replacement history command (specific first command) to the printer 40 when the operator instructs the host computer 20 to send the get printer replacement history command (or automatically as described above).

As described above, this embodiment of the invention provides a printer and a print control method that enable determining the replacement status of each printer 40 (such as the replacement frequency of individual printers 40, and the replacement frequency of all printers 40 in a business), and as a result enables forecasting problems specific to a particular printer location (such as a particular checkout lane in a store), and problems specific to the business (store), and thereby enable easily devising an appropriate solution.

This is the result of the printer replacement information writer 50d writing printer replacement information at specific times through an RJ11 connector 48 (interface) to nonvolatile memory 34, and being able to know the printer replacement status by displaying on a display or printing out the printer replacement information that is written to the nonvolatile memory 34.

Note that the nonvolatile memory 34 in the foregoing embodiment is related to a specific printer location (checkout lane) by attaching the nonvolatile memory 34 (memory module 30) to a LAN cable C1, but the invention is not so limited. For example, the nonvolatile memory 34 may be linked to a specific printer location (checkout lane) by connecting the nonvolatile memory 34 (memory module 30) to a specific printer location (such as the table or other place near where the printer 40 is located) by means of a cable or other connector.

Furthermore, the printer 40 in the foregoing embodiment sends (reports) printer replacement information (printer replacement history and printer replacement count) stored in the nonvolatile memory 34 to the host computer 20 when the printer 40 determines that a specific command (such as a get printer replacement count command) sent from the host computer 20 was received, but the invention is not so limited. For example, the printer 40 may send (report) printer replacement information (printer replacement history and printer replacement count) stored in the nonvolatile memory 34 to the host computer 20 at a regular or irregular interval (such as several minutes) independently of receiving a specific command.

Furthermore, the memory module 30 (nonvolatile memory 34) in this embodiment is described as using an RJ11 connector 48 as the interface to which the memory module 30 (nonvolatile memory 34) is connected, but the invention is not so limited and other types of connectors may be used.

The foregoing embodiment is also described as determining if the printer serial number stored in the history storage area identified by a pointer stored in the newest history pointer storage area 60C matches the printer serial number stored in ROM 42c of the printer 40, and determining the printer 40 was replaced if the serial numbers do not match, but the invention is not so limited. For example, the printer 40 may determine if the MAC address stored in the history storage area identified by a pointer stored in the newest history pointer storage area 60C matches the MAC address stored in ROM 42c of the printer 40, and determine the printer 40 was replaced if the MAC addresses do not match.

Furthermore, a receipt printer is used as an example of the printer 40 in the foregoing embodiment, but the invention is not so limited and may be applied to printers other than receipt printers.

The foregoing embodiment is in all aspects only an example. The invention should not be understood as being limited by the foregoing description. The invention can be embodied in many other ways without departing from the spirit or main features described above.

What is claimed is:

1. A printer disposed to a printer location, and comprising:
an interface to which memory associated with the printer location is removably connected; and
a printer replacement information writer configured to write printer replacement information through the interface to the memory at a specific time.

2. The printer described in claim 1, wherein:
the printer replacement information includes at least one of an identifier, IP address, lane ID, printer replacement history, and printer replacement count.

3. The printer described in claim 2, wherein:
the identifier is the serial number of the printer, or the MAC address of the printer.

4. The printer described in claim 2, wherein:
the printer determines if the identifier of the printer matches the printer identifier stored in the memory, and determines the printer was replaced if the identifiers do not match.

5. A control method of a printer that is disposed to a printer location and has an interface to which memory associated with the printer location is removably connected, the control method comprising:
a printer replacement information writing step of writing printer replacement information through the interface to the memory at a specific time.

6. A printer disposed to a printer location, and comprising:
an interface to which memory associated with the printer location is removably connected;
a printer replacement information writer configured to write printer replacement information through the interface to the memory; and
a communicator configured to communicate with a host computer, and send the printer replacement information stored in the memory to the host computer at a specific time.

7. The printer described in claim 6, wherein:
the communicator sends information related to an error of the memory to the host computer when a specific second command is received from the host computer.

8. A control method of a printer disposed to a printer location, and having an interface to which memory associated with the printer location is removably connected, the control method comprising:
a printer replacement information writing step of writing printer replacement information through the interface to the memory; and
a printer replacement information transmission step of sending the printer replacement information stored in the memory to the host computer at a specific time.
